(19) United States
(12) Patent Application Publication
(10) Pub. No.: US 2025/0219918 A1
(43) Pub. Date: Jul. 3, 2025

(54) TRACKING AREA CODE (TAC) AUDIT AND SEARCH IN A 5G CLOUD-BASED COMMUNICATION NETWORK

(71) Applicant: DISH Wireless L.L.C., Englewood, CO (US)

(72) Inventors: Kenneth William Weber, JR., Littleton, CO (US); Ravi Madhavan, Napervile, IL (US); Mohammad Dawood Shahdad, Aurora, CO (US); Yugender Reddy Vadyala, Highlands Ranch, CO (US)

(21) Appl. No.: 18/397,972

(22) Filed: Dec. 27, 2023

(51) Int. Cl. H04L 43/06; H04W 64/00

(52) U.S. Cl. CPC H04L 43/06; H04W 64/00

(57) ABSTRACT

A method for performing an audit of tracking area codes (TAC) in a cloud-based communication network having a plurality of regions and a plurality of availability zones within each region includes collecting, using a TAC audit module, a list of TACs from each element in a plurality of predetermined elements and storing, using the TAC audit module, the collected list of TACs for each predetermined element. The method further includes, for each region and availability zone, comparing, using the TAC audit module, the lists of TACs for elements for which the lists of TACs should match, identifying, using the TAC audit module, errors based on the comparison of the lists of TACs, storing, using the TAC audit module, the results of the comparison including any identified errors, and generating, using the TAC audit module, a report comprising at least the results of the comparison and the collected list(s) of TACs.

### FIELD

The present disclosure relates generally to wireless communication networks and, more particularly, systems and methods for performing an audit of tracking area codes (TACs) in a cloud-based communication network and for determining a location of one or more TACs in the communication network using the TAC audit results.

### BACKGROUND

Wireless communication networks that transport digital data and telephone calls are becoming increasingly sophisticated. Currently, fifth generation (5G) communication networks, are being deployed around the world. These 5G networks use emerging technologies to support data and voice communications with millions, if not billions, of mobile phones, computers, and other devices. 5G technologies are capable of supplying much greater bandwidths than was previously available.

### SUMMARY

In accordance with an embodiment, a method for performing an audit of tracking area codes (TAC) in a cloud-based communication network, where the communication network has a plurality of regions and a plurality of availability zones within each region, includes collecting, using a TAC audit module, a list of TACs from each element in a plurality of predetermined elements of the communication network and storing, using the TAC audit module, the collected list of TACs for each predetermined element in a storage device. The method further includes, for each region and availability zone of the communication network, comparing, using the TAC audit module, the lists of TACs for elements for which the lists of TACs should match; identifying, using the TAC audit module, errors based on the comparison of the lists of TACs, storing, using the TAC audit module, the results of the comparison including any identified errors in the storage device, and generating, using the TAC audit module, a report comprising at least the results of the comparison and the list of TACs collected for each predetermined element.

In accordance wither another embodiment, a system for performing an audit of tracking area codes (TAC) in a cloud-based communication network, where the communication network has a plurality of regions and a plurality of availability zones within each region, includes a memory that stores one or more computer readable media that include instructions, and one or more processor devices that execute the instructions of the computer readable media to perform a process. The process includes collecting a list of TACs from each element in a plurality of predetermined elements of the communication network, and storing the collected list of TACs for each predetermined element in a storage device. The process further includes, for each region and availability zone of the communication network, comparing the lists of TACs for elements for which the lists of TACs should match, identifying errors based on the comparison of the lists of TACs, storing the results of the comparison including any identified errors in the storage device, and generating a report comprising at least the results of the comparison and the list of TACs collected for each predetermined element.

In accordance with another embodiment, a non-transitory, a non-transitory, computer-readable medium storing instructions that, when executed by one or more electronic processors, perform a set of functions, and the set of functions includes collecting, using a TAC audit module, a list of TACs from each element in a plurality of predetermined elements of a communication network having a plurality of regions and a plurality of availability zones within each region, and storing, using the TAC audit module, the collected list of TACs for each predetermined element in a storage device. The set of functions further includes, for each region and availability zone of the communication network, comparing, using the TAC audit module, the lists of TACs for elements for which the lists of TACs should match, identifying, using the TAC audit module, errors based on the comparison of the lists of TACs, storing, using the TAC audit module, the results of the comparison including any identified errors in the storage device, and generating, using the TAC audit module, a report comprising at least the results of the comparison and the list of TACs collected for each predetermined element.

### BRIEF DESCRIPTION OF THE DRAWINGS

The present disclosure will hereafter be described with reference to the accompanying drawings, wherein like reference numerals denote like elements.

FIG. 1 is a schematic block diagram of an example wireless communication network in accordance with an embodiment;

FIG. 2 illustrates an example of tracking areas (TAs) and tracking area codes (TACs) in a communication network in accordance with an embodiment;

FIG. 3 is a schematic block diagram of a system for performing an audit of tracking area codes (TAC) in a cloud-based communication network in accordance with an embodiment;

FIG. 4A illustrates a method for performing an audit of tracking area codes (TAC) in a cloud-based communication network in accordance with an amendment;

FIG. 4B illustrates a method for determining a location of one or more TACs in a cloud-based communication network in accordance with an embodiment; and

FIG. 5 is a block diagram of an example computer system in accordance with an embodiment.

### DETAILED DESCRIPTION

A plurality of hardware and software-based devices, as well as a plurality of different structural components can be used to implement the disclosed technology. In addition, examples of the disclosed technology can include hardware, software, and electronic components or modules that, for purposes of discussion, can be illustrated and described as if the majority of the components were implemented solely in hardware. However, in at least one example, the electronic based aspects of the disclosed technology can be implemented in software (for example, stored on non-transitory computer-readable medium) executable by one or more electronic processors. Although certain drawings illustrate hardware and software located within particular devices, these depictions are for illustrative purposes only. In some examples, the illustrated components can be combined or divided into separate software, firmware, hardware, or combinations thereof. As one example, instead of being located within and performed by a single electronic processor, logic and processing can be distributed among multiple electronic processors. Regardless of how they are combined or divided, hardware and software components can be located on the same computer device or can be distributed among different computing devices connected by one or more networks or other suitable communication links.

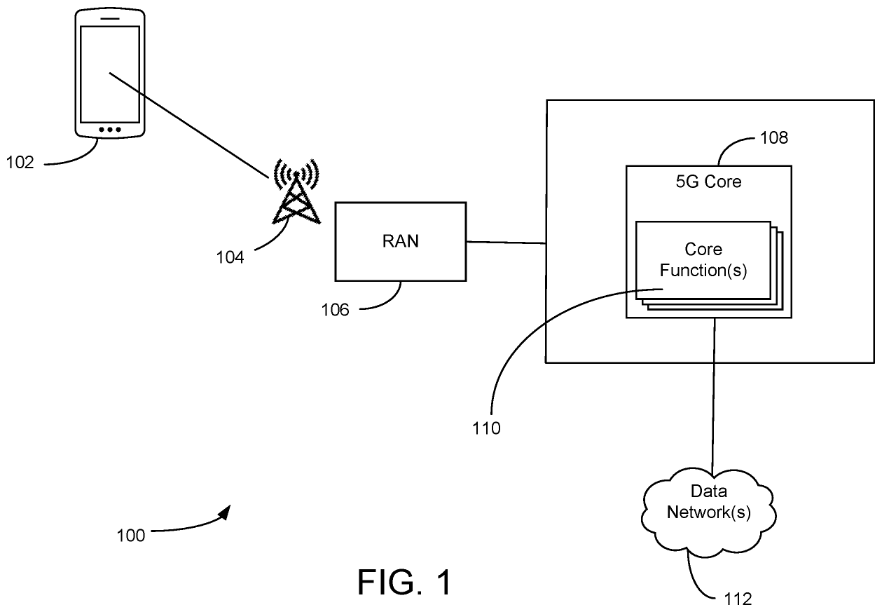

FIG. 1 is a schematic block diagram of an example wireless communication network in accordance with an embodiment. The wireless communication network 100 can include a user equipment (UE) device 102, a radio access network (RAN) 106, and a 5G core 108. The RAN 106 and 5G core 108 can enable the UE device 102 to, for example, communicate with other UE devices and to communicate with one or more external data networks (DNS) 112 (e.g., the Internet or a private corporate network) using the RAN 106 and 5G core 108. For example, if the external data network 112 is the Internet, the RAN 106 and 5G core 108 can allow the UE device 102 to send and receive data via the Internet. While FIG. 1 illustrates various components of communication network 100, other embodiments of communication network 100 can vary the arrangement, communication paths, and specific components of communication network 100. In some embodiments, the wireless communication network 100 can include fewer, additional, or different components in different configurations than illustrated in FIG. 1. For example, in some embodiments, the wireless communication network 100 may include additional or different UE devices 102.

The wireless communication network 100 may be used to facilitate multiple types of communication sessions, such as, for example, voice calls, video calls, messaging, data transmission, and/or other types of communications. The wireless communication network 100 may represent a portion of a wireless network built around 5G (fifth generation) standards promulgated by standards setting organizations under the umbrella of the Third Generation Partnership Project (3GPP). Accordingly, in some configurations, the wireless communication network 100 may be a 5G network, such as, for example, a 5G cellular network. Such 5G networks, including the wireless communication network 100, may comply with industry standards, such as, for example, the Open Radio Access Network (Open RAN or O-RAN) standard that describes interactions between the network and user equipment (e.g., mobile phones and the like). The O-RAN model follows a virtualized model for a 5G wireless architecture in which 5G base stations (gNBs) are implemented using separate centralized units (CUs), distributed units (DUs), and radio units (RUs). In some configurations, O-Ran CUs and DUs may be implemented using software modules executed by distributed (e.g., cloud) computing hardware.

In some configurations, the wireless communication network 100 may be a standalone (SA) network (e.g., a 5G SA network) that utilizes 5G cells for both signaling and information transfer via a 5G packet core architecture. In other configurations, the wireless communication network 100 may be a non-standalone (NSA) network that depends on another network, such as, for example, a control plane of a fourth generation (4G) long-term evolution (LTE) network.

As mentioned, in some embodiments, the UE device 102 can transmit data from one or more applications on the UE device 102 to an external data network (DN) 112, for example, the Internet, via the communication network 100. While FIG. 1 illustrates one UE device 102, in some embodiments, it should be understood that the communication network 100 can support a plurality of UE devices 102. UE device 102 can be various forms of wireless devices that are capable of communication according to the radio access technology (RAT) of the wireless communication network 100 (e.g., a 5G new radio (NR) network). For example, in some embodiments, the UE device 102 can be a smartphone, a wireless modem, a cellular phone, a laptop computer, a wireless access point (AP), etc.

After the UE device 102 has established a connection or session with the RAN 106, the communication network 100 can provide data (e.g., data packets) to the UE device 102 and can receive data from the UE device 102. In some embodiments, the data can include, for example, voice data for a phone call, data provided by a web server to the UE device 102, data provided by the UE device 102 to a Web server, or other types of data commonly exchanged on wireless communication networks. For example, after the UE device 102 has established a connection or session with the RAN 106, a user of the UE device 102 may select to stream a video on an application of the UE device 102 via the Internet (e.g. data network 112). The video stream can be provided to the UE device 102 on data packets.

The UE device 102 can communicate with the RAN 106 in various ways, such as, for example, via a radio transceiver 104, which may also be referred to as a radio unit (RU) in the O-RAN architecture. The RAN 106 may be or include a disaggregated RAN (referred to as an Open RAN or O-RAN) which can include hierarchy (e.g., tree structure) of RAN functions. In such examples, the RAN 106 may include one or more CUs and one or more DUs. For example, each of multiple CUs may be coupled with multiple DU, and each DU may be coupled with multiple RUs (e.g., the radio transceiver 104). As such, each UE device 102 can communicate with backhaul network infrastructure (e.g., a 5G Core 108) according to an assigned communication path through a particular RU, DU, and CU. An RU (e.g., the radio transceiver 104) in combination with a DU and CU may be referred to as a gNodeB (gNB) in the O-RAN architecture. Such a gNB may be a 3GPP 5G next generation base station that supports communications with the with the UE device 102.

The 5G Core 108 may include one or more core functions 110. Each core function 110 can be a network function (NF) that provides a utility or service specific to the 5G core 108, for example, core functions of the communication network 100. In some embodiments, for example, different NFs may provide different utility to the communication network 100. In some embodiments, the 5G core 108 including the core functions 110 can reside on a cloud computing platform. For example, in some embodiments, the communication network (e.g., communication network 100), or portion thereof, in which the 5G core 108 is implemented may be disaggregated, such that, for example, NFs may be developed or operated by multiple vendors or operators. In some embodiments, an NF may be virtualized. An NF may be virtualized by implementing the NF in a cloud-native architecture. Accordingly, in some embodiments, an NF may be a cloud-native NF (CNF). A CNF may refer to a service (or utility) that performs network duties in software (e.g., as opposed to purpose-built hardware).

Examples of various core functions 110 can include a Network Slice Selection Function (NSSF), a Network Exposure Function (NEF), a Network Repository Function (NRF), a policy control function (PCF), a Unified Data Management (UDM) function, an Authentication Server Function (AUSF), an Access and Mobility Management Function (AMF), a Session Management Function (SMF), and a User Plane Function (UPF). The NSSF can provide tailor made logical networks on the physical network, for example, the NSSF can be used by the AMF to assist with the selection of a network slice that will serve a particular UE device. The NEF can expose services and resources over application programming interfaces (APIs) within and outside the 5G core. The NRF can enable 5G network functions (NFs) to register and discover each other via a standards-based application programming interface (API). The PCF can apply session policies for a UE device, or other devices, when connecting over, for example, 5G. The UDM can manage network user data in a single, centralized element and can allow for generation of authentication vectors, user identification handling, NF registration management, and retrieval of UE device individual subscription data for slice selection. The AUSF can allow the AMF to authenticate the UE and access services of the 5G core 108. The AMF can perform operations like mobility management, registration management, connection management, UE-based authentication, etc. The SMF can interact with the decoupled data plane, can perform internet protocol (IP) address allocation and management for UE devices (e.g., UE device 102), user plane selection, and packet routing in conjunction with the UPF, etc. The UPF can perform user plane operations, such as maintaining protocol data unit (PDU) sessions, packet routing and forwarding, inspection policy enforcement for the user plane, Quality of Service (QOS) handling, providing data access to the UE 102, etc. A PDU session can provide connectivity between applications on the UE device 102 and the DN 112 (e.g., the Internet). The SMF can also be responsible for creating, updating, and removing PDU sessions, selecting particular UPFs on which to anchor PDU sessions when new UE devices 102 appear on the communication network, and managing session context with the UPF. Together with the UPF, the SMF can maintain a record of PDU session state by means of a PDU Session ID. The above-listed NFs and interfaces are intended to be illustrative and not exhaustive.

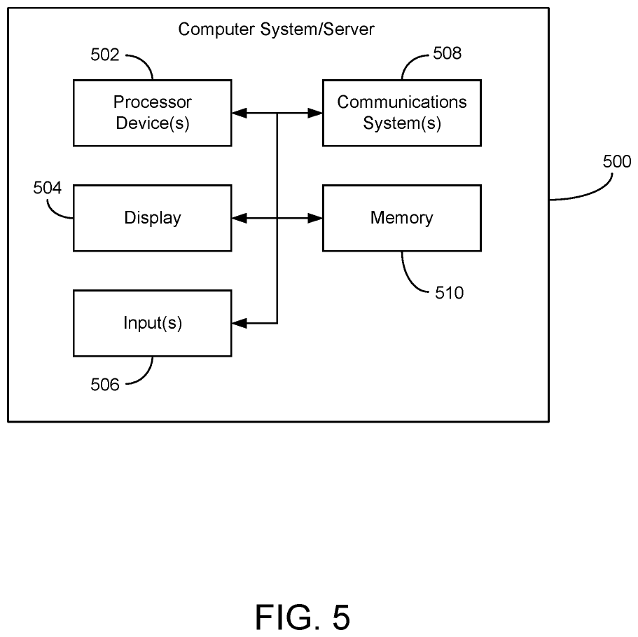

In some embodiments, the RAN 106 and the 5G core 108 (including core functions 110) may be implemented on a computer system (e.g., computer system 500 discussed below with respect to FIG. 5) such as a server or the functionality of the RAN 106, the 5G core 108 and core functions 110 may be distributed among multiple servers or devices (e.g., as part of a cloud service or cloud-computing environment). In some embodiments, the 5G core 108 can be physically distributed across data centers or located at a central national data center (NDC) (e.g., the 5G core can logically reside as part of an NDC). Within an NDC, multiple regional data centers (RDCs) can be logically present. In some embodiments, each of such one or more regional data centers may execute core functions 110 for a different geographic region or a group of RAN components.

In some embodiments, the communication network 100 may be configured according to a region-based network topology. For example, the communication network 100 may be implemented using a cloud computing platform that is logically and physically divided up into various different cloud computing regions (e.g., AWS regions). The cloud computing regions may be based on the geographical location of the gNBs; for example, the communication network 100 for a given nation may be divided into a number of geographical regions. Each of the cloud computing regions can be isolated from other cloud computing regions to help provide fault tolerance, fail-over, load-balancing, and/or stability and each of the cloud computing regions can be composed of multiple availability zones or markets, each of which can be a separate data center located in general proximity to each other (e.g., within 100 miles). For example, one cloud computing region may have its datacenters and hardware located in the northeast of the United States while another cloud computing region may have its data centers and hardware located in California. Each of the availability zones may be a discrete data center or group of data centers that allows for redundancy, thereby to provide fail-over protection from other availability zones within the same cloud computing region. For example, when a particular data center of an availability zone experiences an outage, another data center of the availability zone or separate availability zone within the same cloud computing region can continue functioning and providing service.

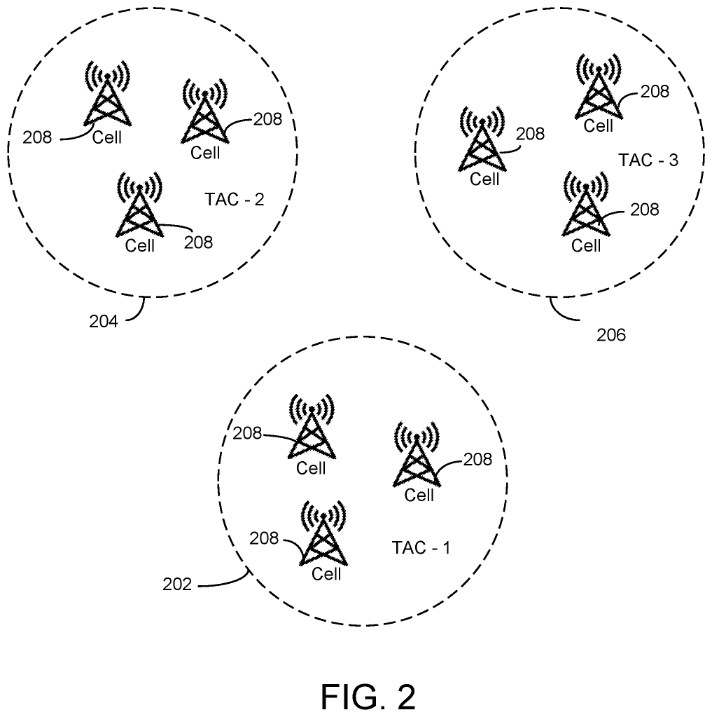

In some embodiments, the communication network may also include a plurality of tracking areas (TAs). Each tracking area can be a group of cells or bases stations (e.g., a gNB) that can be implemented, for example, in a cell tower. FIG. 2 illustrates an example of tracking areas (TAs) and tracking area codes (TACs) in a communication network in accordance with an embodiment. In FIG. 2, a first tracking area (TA) 202 includes a plurality of cells 208, a second tracking area 204 includes a plurality of cells 208, and a third tracking area 206 includes a plurality of cells 208. The cells 208 in a particular tracking area can be in a similar geographic region. Each tracking area 202, 204, 206 has an associated tracking area code (TAC) that is shared by each cell 208 in the tracking area. For example, the first tracking area 202 has a first TAC (TAC-1), the second tracking area 204 has a second TAC (TAC-2), and the third tracking area 206 has a third TAC (TAC-3). Each TAC is an identifier (e.g., a unique number within the network) of the associated tracking area within the communication network and can, for example, be used to track a call through a communication network. Returning again to FIG. 1, a TAC can be used to establish the location of the UE device 102 (e.g., a mobile subscriber) in the communication network 100 (e.g., identify where the specific UE device 102 is connected to in the network 100). For example, in some embodiments, a TAC may be required to address a UE device 102 in the case of an incoming call. In some embodiments, TACs for the communication network 100 can be populated in various elements or nodes in the communication network 100 to, for example, facilitate the routing of calls. In some embodiments, one or more TACs may be populated in, for example, one or more network functions such as core functions 110 of the 5G core 108. For example, various elements (e.g., NFs) of the communication network 100 can include a list of TACS that are supported by the element or node. Within a region of the communication network 100, various elements or nodes (e.g., NFs) that are populated with TACs may need to be in sync, namely, the TAC list for each element should be the same. TAC provisioning (e.g., the data entry of what and where), however, is a complex task, and sometimes there can be misconfigured TAC data (e.g., missing TACs that can result in a TAC mismatch) at one or more elements or nodes of the network that are populated with TACs. Misconfigured TAC data can cause problems in the network such mishandled calls, for example, dropped or rejected calls.

The present invention discloses a system and method for performing an audit of tracking area codes (TAC) in a cloud-based communication network. In some embodiments, a TAC audit module may be provided that is configured to detect and report errors with TAC lists (e.g., a missing TAC) for various elements in the communication network. The TAC audit module can communicate with a plurality of predetermined elements or nodes in the communication network, namely, elements that are populated with TACs. In some embodiments, the predetermined elements can be network functions of the communication network such as, for example, an access and mobility management function (AMF) and a session management function (SMF). When initiated, the TAC audit module can be configured to collect a list of TACs from each predetermined element that is populated with TACs. The collected list of TACs for each predetermined element can be stored in, for example, a data storage device. TAC lists for elements for which the TAC lists should match (e.g., be in sync) can then be compared to identify any errors, for example, a TAC may be missing from one of the compared TAC lists. The results of the comparison including any identified errors can also be stored in, for example the storage device. The TAC audit module may also be configured to generate a report with the collected list of TACs for each predetermined element and the results of the comparison. Advantageously, the disclosed TAC audit module provides an automated mechanism to identify TAC errors for various elements (e.g., NFs) in the communication network. An administrator may use the generated report to identify, for example, any TAC mismatches that may be causing call mishandling in the communication network. In some embodiments, a TAC search module may also be provided that may be configured to identify a location of a given TAC using the TAC audit results, for example, the lists of TACs collected from performing a TAC audit.

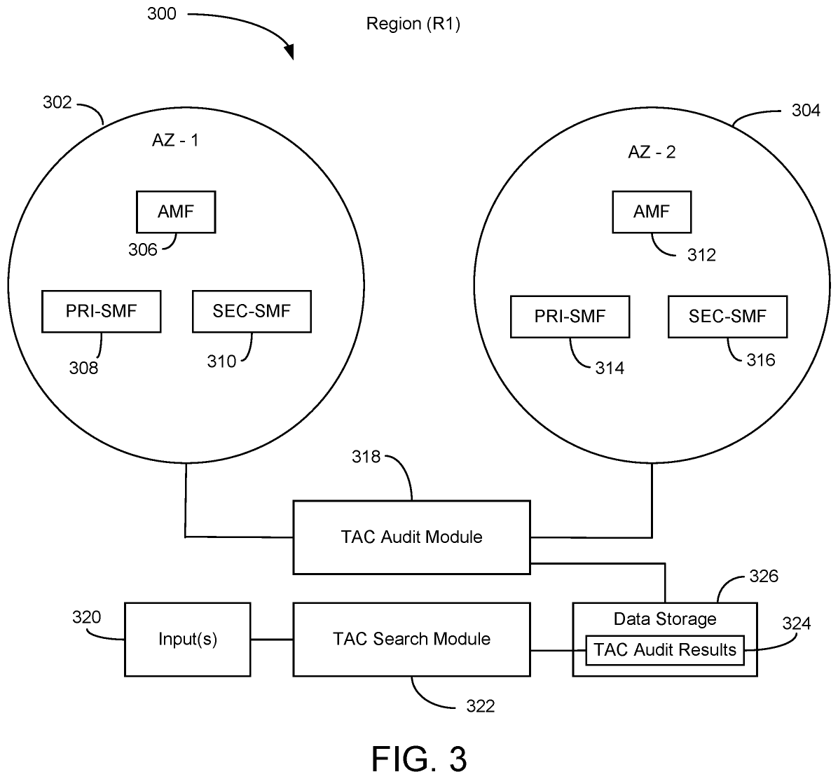

FIG. 3 is a schematic block diagram of a system for performing an audit of tracking area codes (TAC) in a cloud-based communication network in accordance with an embodiment. FIG. 3 illustrates a region (R1) 300 of a communication network (e.g., communication network 100 shown in FIG. 1) that includes two availability zones, namely, a first availability zone (AZ-1) 302 and a second availability zone (AZ-2) 304. While one region is illustrated in FIG. 3 for simplicity, it should be understood that the communication network can include a plurality of regions e.g., (R1, R2, R3, . . . . Rn). In addition, while two availability zones 302 and 304 are illustrated in FIG. 3 for simplicity, it should be understood that a region, such as region R1 300 can include more than two availability zones. The first availability zone 302 and the second availability zone 304 can each include a plurality of elements or nodes such as, for example, network functions. In FIG. 3, the first availability zone 302 can include AMF 306, a primary SMF (PRI-SMF) 308 and a secondary SMF (SEC-SMF) 310. The second availability zone 304 can include an AMF 312, a primary SMF (PRI-SMF) 314 and a secondary SMF (SEC-SMF) 316. In FIG. 3, the example availability zones 302, 304 are simplified to show some key elements, however, implementations can include additional elements. AMF 306 and AMF 312 can be configured to be populated with tracking area codes (TACs) and, therefore, each AMF 302, 312 can include a list of TACs that the particular AMF 306, 312 knows about and therefore can recognize and support for a call. In the first availability zone 302, the primary SMF 308 and the secondary SMF 310 can be configured to be populated with TACs and, therefore, each SMF 308, 310 can include a list of TACs that the particular SMF 308, 310 knows about and therefore can recognize and support for a call. In the second availability zone 304, the primary SMF 314 and the secondary SMF 316 can be configured to be populated with TACs and, therefore, each SMF 314, 316 can include a list of TACs that the particular SMF 314, 316 knows about and therefore can recognize and support for a call.

As discussed above, each region of a communication network (e.g., implemented on a cloud-computing platform) can be composed of multiple availability zones to allow for redundancy to provide, for example, fail-over protection from other availability zones within the same region. For example, when a particular data center of an availability zone experiences an outage, another data center of the availability zone or separate availability zone within the region can continue functioning and providing service. In some embodiments, the AMF 312 of the second availability zone 304 can provide backup to the AMF 306 of the first availability zone 302, and vice versa. Accordingly, the list of TACs of the AMF 306 and the list of TACs of the AMF 312 should be in sync, i.e., the lists should be the same. In some embodiments, the secondary SMF 316 of the second availability zone 304 can provide backup to the primary SMF 308 of the first availability zone 302 and the secondary SMF 310 of the first availability zone 302 can provide backup to the primary SMF 314 of the second availability zone 304. Accordingly, the list of TACs of the primary SMF 308 in the first availability zone 302 and the list of TACs of the secondary SMF 316 in the second availability zone 304 should be the same. In addition, the list of TACs of the primary SMF 314 in the second availability zone 304 and the list of TACs of the secondary SMF 310 in the first availability zone 302 should be the same. In the first availability zone 302, the primary SMF 308 and the secondary SMF 310 can be associated with and communicate with the AMF 306 during a session. Accordingly, the list of TACs of the AMF 306 should be the same as the combination of the list of TACs for the primary SMF 308 and the list of TACs for the secondary SMF 310. In the second availability zone 304, the primary SMF 314 and the secondary SMF 316 can be associated with and communicate with the AMF 312 during a session. Accordingly, the list of TACs of the AMF 312 should be the same as the combination of the list of TACs for the primary SMF 312 and the list of TACs for the secondary SMF 316.

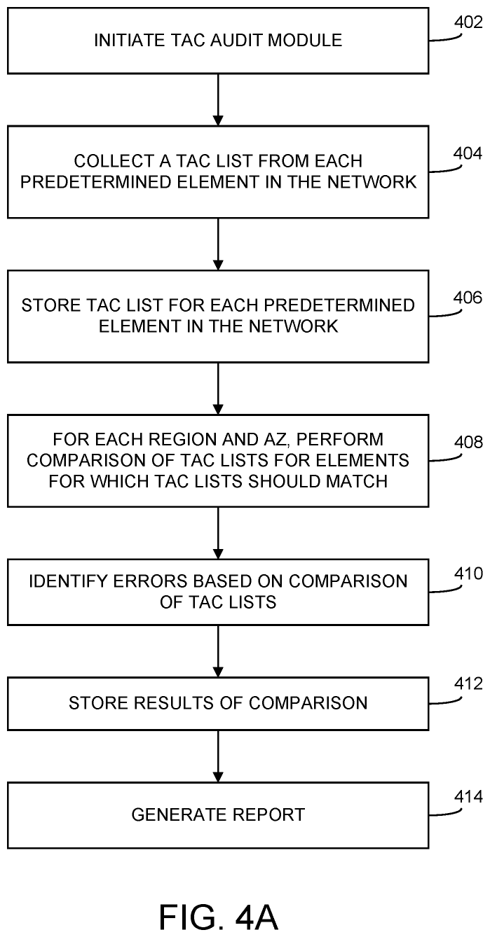

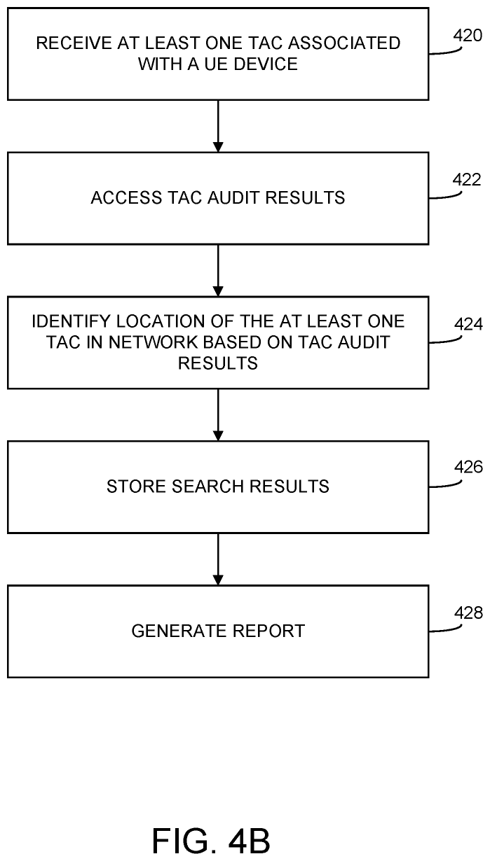

As discussed above, differences between the TAC lists for elements where the lists of TACs should match (i.e., be in sync) can cause problems such as, for example, dropped or refused calls. The system illustrated in FIG. 3 advantageously include a TAC audit module 318 that can access and communicate with the various elements (e.g., AMF 306, primary SMF 308, secondary SMF 310, AMF 304, primary SMF 314, secondary SMF 316) in each availability zone 302, 304 of the region 300. While only one region (R1) 300 and two availability zones 320, 304 are shown in FIG. 3, it should be understood that TAC audit module 318 may be configured to access and communicate with various predetermined elements (e.g., elements that are populated with TACs) in every region and availability zone in the communication network. Accordingly, the TAC audit module 318 can be configured to collect TAC lists from the predetermined elements in the entire communication network. The collected TAC lists can be stored as part of the TAC audit results 324 in, for example, data storage 326. The TAC audit module 318 can also be configured to identify any errors in the collected TAC lists. In some embodiments, the TAC audit module 318 can be configured to identify errors in the collected TAC lists by comparing TAC lists of elements for which the TAC lists should match. For example, as discussed further below with respect to FIG. 4A, the TAC list of AMF 306 and the TAC list of AMF 312 may be compared, the TAC list of primary SMF 308 and the TAC list of secondary SMF 316 may be compared, and the TAC list of primary SMF 314 and the TAC list of secondary SMF 310 may be compared. In some embodiments, within the first availability zone 302, the TAC list of AMF 306 may be compared to the combination of the TAC lists of the primary SMF 308 and the secondary SMF 310, and within the second availability zone 304 the TAC list of the AMF 312 may be compared to the combination of the TAC lists of the primary SMF 314 and the secondary SMF 316. While various elements of only one region (R1) 300 and two availability zones 320, 304 are shown in FIG. 3, it should be understood that TAC audit module 318 may be configured perform the comparison of TAC lists for various elements for each region and availability zone in the communication network. The results of the comparison of the TAC lists of various elements (including the identification of any errors) can be stored as part of the TAC audit results 324 in, for example, data storage 326. The TAC audit results 324 can include the collected TAC lists for each predetermined element and the comparison results.

In some embodiments, a TAC search module 322 may be provided and can be configured to, for example, determine a location of one or more TACs. If an administrator is tasked with investigating a problem for a UE device (e.g., UE device 102 shown in FIG. 1), such as, for example, a dropped call, the administrator may provide input(s) 320 to the TAC search module 322. In some embodiments, the input(s) 320 can include one or more TACs associated with the UE device. In some embodiments, the input(s) 320 may be provided by an operator or administrator using a user interface (e.g., inputs 506 shown in FIG. 5) configured to allow a user to interact with the system. Based on the input one or more TACs, the TAC search module can access the TAC audit results 324 and identify a location for each of the input TACs in the communication network based on the TAC lists collected for each predetermined element. For example, the location of the TAC may be one or more elements that include the TAC in its list of TACs that can be recognized and supported by the element for a call. The identified location for the one or more TACs can be stored in, for example, data storage 326. In some embodiments, the TAC audit module 328 and the TAC search module 322 may be implemented on a computer system (e.g., computer system 500 discussed below with respect to FIG. 5) such as a server.

FIG. 4A illustrates a method for performing an audit of tracking area codes (TAC) in a cloud-based communication network in accordance with an amendment. The process illustrated in FIG. 4A is described as being carried out by the system illustrated in FIGS. 1 and 3. Although the blocks of the process are illustrated in a particular order, in some embodiments, one or more blocks may be executed in a different order than illustrated in FIG. 4A, or may be bypassed.

At block 402, a TAC audit module 318 may be initiated by, for example, a network administrator or other user. At block 404, a TAC list from each predetermined element (e.g., an NF) in a plurality of predetermined elements of a communication network may be collected using the TAC audit module 318. In some embodiments, the plurality of predetermined elements are elements that are populated with TACs and the elements can be in or associated with each region and availability zone in the communication network. Accordingly, TAC lists may be collected from predetermined elements in the entire communication network. At block 406, the collected lists of TACs can be stored in, for example, data storage 326. In some embodiments, the collected lists of TACs from the plurality of predetermined elements may be stored as part of TAC audit results 324.

At block 408, a comparison of collected TAC lists for elements for which the TAC lists should match may performed by the TAC audit module 318 and at block 410, errors in the collected TAC lists may be identified based on the comparison. The comparison at block 408 may be performed for elements in each region and availability zone (AZ) in the communication network. In some embodiments, the comparison of collected TAC lists for elements for which the TAC lists should match can include comparing a TAC list for a first element and a TAC list for a second element that is configured to be a backup for the first element. As discussed above with respect to the example communication network region R1 300 illustrated in FIG. 3, an AMF 312 in a second availability zone 304 of region 300 can be configured to be a backup to an AMF 306 in a first availability zone 302 of region 300, and vice versa. Accordingly, the list of TACs of the AMF 306 and the list of TACs of the AMF 312 should be in sync, i.e., the lists should be the same. To determine if there are any differences (or errors) in the TAC list for AMF 306 and/or the TAC list for AMF 312, the TAC audit module 318 can compare the two TAC lists to determine, for example, if there are any TACs that are in one of the TAC lists but not in the other TAC list. In some embodiments, the comparison of the TAC list for AMF 306 and the TAC list for AMF 312 may be performed using a set comparison. For example, each TAC list is a data set and the TAC list data set for the AMF 312 may first be subtracted from TAC list data set for the AMF 306, as given by: AMF(306)-AMF(312). If the two TAC list data sets for AMF 306 and AMF 312 are the same (i.e., the same TACs are included in each list), the result will be an empty set which can be given by: AMF(306)-AMF(312)=[ ]. If there are TACs in the TAC list for AMF 306 that are not in the TAC list for AMF 312 (i.e., an error), the result of the comparison will identify these specific TACs. In some embodiments, the set comparison can also be done in the opposite direction to determine if there are any TACs in the TAC list for AMF 312 that are not in the TAC list for AMF 306. Accordingly, the TAC list data set for the AMF 306 may be subtracted from TAC list data set for the AMF 312, as given by: AMF(312)-AMF(306). If there are no differences in the TAC list for the AMF 312 and the TAC list for AMF 306 based on this comparison, the result will be an empty set which can be given by: AMF(312)-AMF(306)=[ ]. If there are TACs in the TAC list for AMF 312 that are not in the TAC list for AMF 306 (i.e., an error), the result of the comparison will identify these specific TACs. In the example illustrated in FIG. 3, as discussed above, the secondary SMF 316 of the second availability zone 304 can provide backup to the primary SMF 308 of the first availability zone 302 and the secondary SMF 310 of the first availability zone 302 can provide backup to the primary SMF 314 of the second availability zone 304. Accordingly, a similar set comparison can be performed for primary SMF 308 and secondary SMF 316 and for primary SMF 314 and secondary SMF 310.

In some embodiments, the TAC lists for elements within the same availability zone may also be compared if the TAC lists for the elements should match. As discussed above with respect to the example communication network region R1 300 illustrated in FIG. 3, in the first availability zone 302, the primary SMF 308 and the secondary SMF 310 can be associated with and communicate with the AMF 306 during a session. Accordingly, the list of TACs of the AMF 306 should be the same as the combination of the list of TACs for the primary SMF 308 and the list of TACs for the secondary SMF 310. In this example, to determine if there are any differences (or errors) in the TAC list for AMF 306 and the combined TAC list of primary SMF 308 and TAC list of the secondary SMF 310, the TAC audit module 318 can compare the TAC list for AMF 306 and the combined TAC list of primary SMF 308 and TAC list for secondary SMF 310. In some embodiments, the comparison of the TAC list for AMF 306 and the combined TAC list of primary SMF 308 and TAC list for secondary SMF 310 may be performed using a set comparison as discussed above. For example, the TAC list of primary SMF 308 and TAC list for secondary SMF 310 may both be subtracted from the TAC list for the AMF 306, as given by AMF(306)-PRI-SMF(308)-SEC-SMF(310). If the TAC list for AMF 306 is the same as the combination of the TAC list for primary SMF 308 and the TAC list for secondary SMF 310, the result will be an empty set which can be given by: AMF(306)-PRI-SMF(308)-SEC-SMF(310)=[ ]. If there are TACs in the TAC list for AMF 306 that are not in the combination of the TAC list for primary SMF 308 and the TAC list for secondary SMF 310, the result of the comparison can identify these specific TACs. In some embodiments, the set comparison can also be done in the opposite direction to determine if there are any TACs in the combination of the TAC list for primary SMF 308 and the TAC list for secondary SMF 310 that are not in the TAC list for AMF 306. Accordingly, the TAC list for the AMF 306 can be subtracted from the combination of the TAC list for primary SMF 308 and the TAC list for secondary SMF 310, as given by PRI-SMF(308)+SEC-SMF(310)-AMF(306). If the combination of the TAC list for primary SMF 308 and the TAC list for secondary SMF 310 is the same as the TAC list for AMF 306, the result will be an empty set which can be given by: PRI-SMF(308)+SEC-SMF(310)-AMF(306)=[ ]. If there are TACs in the combination of the TAC list for primary SMF 308 and the TAC list for secondary SMF 310 that are not in the TAC list for AMF 306, the result of the comparison can identify these specific TACs. As discussed above with respect to the example communication network region R1 300 illustrated in FIG. 3, in the second availability zone 304, the primary SMF 314 and the secondary SMF 316 can be associated with and communicate with the AMF 312 during a session. Accordingly, the list of TACs of the AMF 312 should be the same as the combination of the list of TACs for the primary SMF 312 and the list of TACs for the secondary SMF 316. Accordingly, a similar set comparison can be performed for the TAC list of AMF 312 and the combined TAC list of primary SMF 314 and the TAC list of secondary SMF 316.

At block 412, the results of the comparison, including any identified errors, may be stored, for example, in data storage 326. In some embodiments, the results of the comparison, including an identified errors, can be stored as part of TAC audit results 324 The TAC audit results 324 can include the collected TAC lists for each predetermined element from block 406 and the comparison results. At block 414, a report may be generated using the TAC audit module 318. In some embodiments, the report can include the TAC audit results 324, for example, the collected TAC lists for each predetermined element from block 406 and the comparison results and any identified errors from blocks 408 and 410. In some embodiments, the report with the TAC audit results may be displayed (e.g., on display 504 shown in FIG. 5) for an administrator to view.

FIG. 4B illustrates a method for determining a location of one or more TACs in a cloud-based communication network in accordance with an embodiment. The process illustrated in FIG. 4B is described as being carried out by the system illustrated in FIGS. 1 and 3. Although the blocks of the process are illustrated in a particular order, in some embodiments, one or more blocks may be executed in a different order than illustrated in FIG. 4B, or may be bypassed.

At block 420, at least one TAC associated with a UE device in the communication network may be received by a TAC search module 322. The UE device may be, for example, a device for which a network administrator is performing an investigation of a problem, for example a dropped call reported by the end user of the UE device. The at least one TAC may be input to the TAC search module 322 by the administrator using, for example, an input 320 such as a user interface. At block 422, the TAC search module 322 can access the TAC audit results 324. In some embodiments, the TAC audit results 324 may be the most recent TAC audit results generated by a TAC audit module 318. As discussed above, in some embodiments, the TAC audit results can include TAC lists collected from a plurality of predetermined elements in the communication network. At block, 424, a location for each of the input TACs in the communication network may be identified based on the TAC lists collected for each of the plurality of predetermined elements. For example, the location of the TAC may be one or more elements in the communication network that include the TAC in its list of TACs that can be recognized and supported by the element for a call. At block 426, the location of the at least one TAC may be stored, for example, in data storage 326. At block 428, a report may be generated using the TAC search module 322. In some embodiments, the report can include the identified locations for the at least one TAC. In some embodiments, the report with the identified locations for the at least one TAC may be displayed (e.g., on display 504 shown in FIG. 5) for an administrator to view.

As mentioned above, various components of the communication network 100 and the disclosed systems in FIGS. 1 and 3 may be implemented on a computer system (e.g., a server). FIG. 5 is a block diagram of an example computer system in accordance with an embodiment. The computer system 500 (e.g., a server) may include one or more processor devices 502, a display 504, one or more inputs 506, one or more communications systems 508, and memory 510. In some embodiments, processor device(s) 502 can be any suitable hardware processor or combination of processors, such as a CPU, a GPU, an ASIC, an EPGA, etc. The processor device(s) 502 may include one or more processors, processor cores, processing elements, processor clusters, or other electronic processing units. Accordingly, a processing function described as being performed by the processor device(s) 502 may include multiple processors, processor cores processing elements, processing clusters, etc. (of processor device(s) 502) performing aspects or portions (subfunctions) of the processing function to complete the processing function. The one or more electronic processing units of the processor device(s) may include one or more microprocessors, application-specific integrated circuits (ASICs), or other suitable electronic device for processing data. At least in some examples, the one or more electronics processing units of the processor device(s) 502 can be co-located physically (e.g., in the same facility, building, room, rack, or computer housing) as part of the computer system 500.

In some embodiments, display 504 can include any suitable display devices, such as a computer monitor, a touchscreen, a television, etc. In some embodiments, display 504 can be omitted. In some embodiments, inputs 506 can include any suitable input devices and/or sensors that can be used to receive user input, such as a keyboard, a mouse, a touchscreen, a microphone, etc. In some embodiments, inputs 506 can be omitted.

In some embodiments, communications system(s) 508 can include any suitable hardware, firmware, and/or software for communicating information over any suitable communication network (e.g., communication network 100 shown in FIG. 1). For example, communication system(s) 508 can include one or more transceivers, one or more communication chips and/or chip sets, etc. In a more particular example, communications system(s) 508 can include hardware, firmware and/or software that can be used to establish a WiFi connection, a Bluetooth connection, a cellular connection, an Ethernet connection, etc.

In some embodiments, memory 510 can include any suitable storage device or devices (e.g., one or more non-transitory computer readable media) that can be used to store instructions, values, etc., that can be used, for example, by processor 502 to present content using display 504, to communicate with a UE 102 (shown in FIG. 1), to communicate with external data network (e.g., the Internet), to communicate with other computer systems (e.g., servers), etc. Memory 510 can include any suitable volatile memory, non-volatile memory, storage, or any suitable combination thereof. For example, memory 510 can include RAM, ROM, EEPROM, one or more flash drives, one or more hard disks, one or more solid state drives, one or more optical drives, etc. The memory 510 may store data and/or instructions for use and execution by the computer system 500 (e.g., by the processor device(s) 502) to implement the functionality of, for example, the RAN 106 and the 5G core 108, both shown in FIG. 1, and the TAC audit module 318 and TAC search module 322, both shown in FIG. 3. In some embodiments, the functionality described herein as being performed by the computer system 500 may be distributed among multiple computer system, servers, or devices (e.g., as part of a cloud service or cloud-computing environment).

In some examples, aspects of the technology, including computerized implementations of methods according to the technology, can be implemented as a system, method, apparatus, or article of manufacture using standard programming or engineering techniques to produce software, firmware, hardware, or any combination thereof to control a processor device (e.g., a serial or parallel general purpose or specialized processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, examples of the technology can be implemented as a set of instructions, tangibly embodied on a non-transitory computer-readable media, such that a processor device can implement the instructions based upon reading the instructions from the computer-readable media. Some examples of the technology can include (or utilize) a control device such as an automation device, a special purpose or general-purpose computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.

Certain operations of methods according to the technology, or of systems executing those methods, can be represented schematically in the FIGs. or otherwise discussed herein. Unless otherwise specified or limited, representation in the FIGs. of particular operations in particular spatial order can not necessarily require those operations to be executed in a particular sequence corresponding to the particular spatial order. Correspondingly, certain operations represented in the FIGs., or otherwise disclosed herein, can be executed in different orders than are expressly illustrated or described, as appropriate for particular examples of the technology. Further, in some examples, certain operations can be executed in parallel, including by dedicated parallel processing devices, or separate computing devices configured to interoperate as part of a large system.

The present technology has been described in terms of one or more preferred embodiments, and it should be appreciated that many equivalents, alternatives, variations, and modifications, aside from those expressly stated, are possible and within the scope of the invention.

1. A method for performing an audit of tracking area codes (TAC) in a cloud-based communication network, where the communication network has a plurality of regions and a plurality of availability zones within each region, the method comprising:
collecting, using a TAC audit module, a list of TACs from each element in a plurality of predetermined elements of the communication network;
storing, using the TAC audit module, the collected list of TACs for each predetermined element in a storage device;
for each region and availability zone of the communication network, comparing, using the TAC audit module, the lists of TACs for elements for which the lists of TACs should match;
identifying, using the TAC audit module, errors based on the comparison of the lists of TACs;
storing, using the TAC audit module, the results of the comparison including any identified errors in the storage device; and
generating, using the TAC audit module, a report comprising at least the results of the comparison and the list of TACs collected for each predetermined element.

2. The method according to claim 1, further comprising:
receiving, using a TAC search module, at least one TAC associated with a user equipment (UE) device in the communication network;
accessing, using the TAC search module, the lists of TACs collected for each predetermined element; and
identifying, using the TAC search module, a location of the at least one TAC in the communication network based on the collected lists of TACs.

3. The method according to claim 1, wherein the plurality of predetermined elements are a plurality of network functions.

4. The method according to claim 1, wherein comparing, using the TAC audit module, the lists of TACs for elements for which the lists of TACs should match further comprises comparing a list of TACs for a first element and a list of TACs for a second element configured to be a backup for the first element.

5. The method according to claim 4, wherein the first element and the second element are the same type of element.

6. The method according to claim 1, wherein comparing, using the TAC audit module, the lists of TACs for elements for which the lists of TACs should match further comprises, for each availability zone, comparing a list of TACs for a first element in the availability zone to a combined list of TACs of a second element and third element in the availability zone.

7. The method according to claim 1, wherein the elements for which the lists of TACs should match are two or more network functions.

8. The method according to claim 2, wherein comparing, using the TAC audit module, the lists of TACs for elements for which the lists of TACs should match comprises performing a set comparison of the lists of TACs.

9. A system for performing an audit of tracking area codes (TAC) in a cloud-based communication network, where the communication network has a plurality of regions and a plurality of availability zones within each region, the system comprising:
a memory that stores one or more computer readable media that include instructions; and
one or more processor devices that execute the instructions of the computer readable media to perform a process comprising:
collecting a list of TACs from each element in a plurality of predetermined elements of the communication network;
storing the collected list of TACs for each predetermined element in a storage device;
for each region and availability zone of the communication network, comparing the lists of TACs for elements for which the lists of TACs should match;
identifying errors based on the comparison of the lists of TACs;
storing the results of the comparison including any identified errors in the storage device; and
generating a report comprising at least the results of the comparison and the list of TACs collected for each predetermined element.

10. The system according to claim 9, wherein the process further comprises:
receiving at least one TAC associated with a user equipment (UE) device in the communication network;
accessing the lists of TACs collected for each predetermined element; and
identifying a location of the at least one TAC in the communication network based on the collected lists of TACs.

11. The system according to claim 9, wherein the plurality of predetermined elements are a plurality of network functions.

12. The system according to claim 9, wherein comparing the lists of YACs for elements for which the lists of TACs should match further comprises comparing a list of TACs for a first element and a list of TACs for a second element configured to be a backup for the first element.

13. The system according to claim 9, wherein comparing the lists of TACs for elements for which the lists of TACs should match further comprises, for each availability zone, comparing a list of TACs for a first element in the availability zone to a combined list of TACs of a second element and third element in the availability zone.

14. The system according to claim 1, wherein comparing the lists of TACs for elements for which the lists of TACs should match comprises performing a set comparison of the lists of TACs.

15. A non-transitory, computer-readable medium storing instructions that, when executed by one or more electronic processors, perform a set of functions, the set of functions comprising:
collecting, using a TAC audit module, a list of TACs from each element in a plurality of predetermined elements of a communication network having a plurality of regions and a plurality of availability zones within each region;
storing, using the TAC audit module, the collected list of TACs for each predetermined element in a storage device;
for each region and availability zone of the communication network, comparing, using the TAC audit module, the lists of TACs for elements for which the lists of TACs should match;
identifying, using the TAC audit module, errors based on the comparison of the lists of TACs;
storing, using the TAC audit module, the results of the comparison including any identified errors in the storage device; and
generating, using the TAC audit module, a report comprising at least the results of the comparison and the list of TACs collected for each predetermined element.

16. The non-transitory computer-readable medium according to claim 15, wherein the plurality of predetermined elements are a plurality of network functions and wherein the elements for which the lists of TACs should match are two or more network functions.

17. The non-transitory computer-readable medium according to claim 15, the set of functions further comprising:
receiving, using a TAC search module, at least one TAC associated with a user equipment (UE) device in the communication network;
accessing, using the TAC search module, the TAC lists collected for each predetermined element; and
identifying, using the TAC search module, a location of the at least one TAC in the communication network based on the collected lists of TACs.

18. The non-transitory computer-readable medium according to claim 15, wherein comparing, using the TAC audit module, the lists of TACs for elements for which the lists of TACs should match further comprises comparing a list of TACs for a first element and a list of TACs for a second element configured to be a backup for the first element.

19. The non-transitory computer-readable medium according to claim 15, wherein comparing, using the TAC audit module, the lists of TACs for elements for which the lists of TACs should match further comprises, for each availability zone, comparing a list of TACs for a first element in the availability zone to a combined list of TACs of a second element and third element in the availability zone.

20. The non-transitory computer-readable medium according to claim 19, wherein the first element in the availability zone is an access and mobility management function (AMF), the second element in the availability zone is a primary session management function (SMF) for the availability zone and the third element in the availability zone is a secondary SMF for the availability zone.
